(19) United States
(12) Patent Application Publication
(10) Pub. No.: US 2025/0124162 A1
(43) Pub. Date: Apr. 17, 2025

(54) ELECTRONIC APPARATUS AND SYSTEM FOR PROVIDING IMAGE WITH MOSAIC FACIAL AREA OF OBJECT AND PROVIDING RESTORED IMAGE TO AUTHORIZED USER

(71) Applicant: GDFLAB CO., LTD., Seoul (KR)

(72) Inventor: Kyoungik JANG, Seoul (KR)

(73) Assignee: GDFLAB CO., LTD., Seoul (KR)

(21) Appl. No.: 18/563,492

(22) PCT Filed: Nov. 6, 2023
(86) PCT No.: PCT/KR2023/017690

§ 371 Date: Nov. 22, 2023

(30) Foreign Application Priority Data
Oct. 12, 2023 (KR) 10-2023-0135680

(51) Int. Cl. G06F 21/62; G06T 3/4023; G06T 9/00; G06V 40/16

(52) U.S. Cl. CPC G06F 21/6245; G06T 3/4023; G06T 9/007; G06V 40/161; G06V 40/168

(57) ABSTRACT

A method of operating an electronic device is disclosed. The method of operating an electronic device according to the present disclosure includes extracting a facial area corresponding to a face of an object within an image, encrypting a feature vector of the facial area, performing downscaling for converting the facial area into a mosaic area to generate a blind image in which the facial area is replaced with the mosaic area in the image, and acquiring an encrypted image by inserting the encrypted feature vector into the blind image.

### BACKGROUND

### Technical Field

The present disclosure relates to an electronic device for providing an image subjected to mosaic processing, and more specifically, to an electronic device that performs mosaic processing on a facial area corresponding to a face of an object in an image, encrypts and encodes an original image, and inserts the original image into the image, to thereby provide an original image with high resolution to an authorized user.

### Background Art

An image mosaic technology is an individual information protection technology for blurring some areas of an image to prevent original content from being recognized. From the perspective of individual information protection, a mosaic technology is mainly used to perform mosaic processing on a portion corresponding to a face of a person. Examples of mosaic technology include methods such as pixelization for making an original image unclear by enlarging pixels in an area requiring mosaic, a blurring method for blurring an image area, and a mosaic pattern for dividing an image into a plurality of grids and randomly mixing the respective grids.

Meanwhile, with the development of artificial intelligence technology, there is an artificial intelligence model that automatically recognizes a face part of an object in an image and performs mosaic processing.

As an example of a related art, Korean Unexamined Patent Publication No. 10-2021-0040702 (Mosaic Generation Device and Method) has been disclosed, but the related art simply generates and provides only a common mosaic video to all users and there have been a disadvantage that an original video is not provided to the users, and a disadvantage that information of the original video with loss is provided.

### SUMMARY

The present disclosure relates to an electronic device that performs mosaic processing on a facial area of an object in an image, and an object thereof is to provide an image with a mosaic facial area to unauthorized users, and providing an image in which an original image is restored with high resolution to authorized users.

Objects of the present disclosure are not limited to the object mentioned above, and other objects and advantages of the present disclosure that are not mentioned can be understood by the following description and will be more clearly understood by embodiments of the present disclosure. Further, it will be obvious that the objects and advantages of the present disclosure can be realized by means defined in claims and combinations thereof.

A method of operating an electronic device according to an embodiment of the present disclosure includes: extracting a facial area corresponding to a face of an object within an image; encrypting a feature vector of the facial area; performing downscaling for converting the facial area into a mosaic area to generate a blind image in which the facial area is replaced with the mosaic area in the image; and acquiring an encrypted image by inserting the encrypted feature vector into the blind image.

In this case, the encrypting of the feature vector of the facial area may include encoding an image of the facial area to extract the feature vector for the facial area; receiving a user input for setting a private code for encrypting the feature vector; and encrypting the feature vector according to the set private code.

Further, the encoding of the image of the facial area to extract the feature vector for the facial area may include generating a low-resolution image by downscaling the image of the facial area; and extracting the feature vector by encoding the low-resolution image.

Meanwhile, the acquiring of the encrypted image by inserting the encrypted feature vector into the blind image may include acquiring the encrypted image by inserting the encrypted feature vector into the blind image on the basis of steganography.

The method of operating an electronic device may include: extracting the encrypted feature vector from the encrypted image and restoring the blind image; extracting the mosaic area constituting the restored blind image; decrypting the encrypted feature vector when the set private code is input; decoding the decrypted feature vector to restore the facial area; and replacing the mosaic area included in the blind image with the restored facial area to generate the decrypted image in which the image has been finally restored.

In this case, the generating of the encrypted image may include generating a DCT image by performing Discrete Cosine Transform (DCT) on the blind image, may include inserting the encrypted feature vector into the DCT image to acquire encrypted data matching the encrypted image, and

the extracting of the encrypted feature vector from the encrypted image and restoring of the blind image may include extracting the encrypted feature vector from the encrypted data matching the encrypted image, and may include restoring the blind image by performing inverse DCT on the encrypted data from which the encrypted feature vector is extracted.

A method of controlling an electronic device according to an embodiment of the present disclosure includes: downscaling a facial area of an object, replacing the facial area with a mosaic area, and extracting a feature vector for a facial area not subjected to the downscaling from an encrypted image into which the feature vector has been encrypted and inserted; restoring the encrypted image into a blind image into which the feature vector is not inserted; decoding the feature vector when a preset private code is input; decoding the decrypted feature vector to restore the facial area; and replacing the mosaic area included in the blind image with the restored facial area to generate the decrypted image in which the image has been finally restored.

In this case, the feature vector may be inserted into the encrypted image on the basis of steganography.

Further, the decoding of the decrypted feature vector to restore the facial area may include generating a high-resolution facial area by upscaling an image of the restored facial area.

A system for providing an image according to an embodiment of the present disclosure includes: an encoder device configured to downscale a facial area of an object for an input image to generate a blind image in which the facial area is replaced with a mosaic area, and extract a feature vector for the facial area to generate an encrypted image in which the feature vector has been encrypted and inserted into the blind image; and a decoder device configured of replace the mosaic area with a restored facial area on the basis of the feature vector of the encrypted image, to generate a decrypted image in which the image has been finally restored, and the encrypted image.

With the electronic device of the present disclosure, it is possible to safely transmit sensitive information through a public channel while preventing the sensitive information from being detected, by hiding information on a facial area of an object in an image within an image file through steganography.

Further, it is possible to effectively restore image data of which the performance has deteriorated in a transmission process, by performing upscaling on the image using an artificial intelligence algorithm.

### BRIEF DESCRIPTION OF THE DRAWINGS

FIG. 1 is a flowchart illustrating an operation in which an electronic device acquires an encrypted image according to an embodiment of the present disclosure.

FIG. 2a is a diagram illustrating an electronic device generating the encrypted image according to an embodiment of the present disclosure.

FIG. 2b is a diagram illustrating the electronic device generating encrypted data on which DCT has been performed according to an embodiment of the present disclosure.

FIG. 3 is a flowchart illustrating the electronic device providing a decrypted image restored through an encrypted image according to an embodiment of the present disclosure.

FIG. 4a is a diagram illustrating the electronic device generating a decrypted image on the basis of an encrypted image according to an embodiment of the present disclosure.

FIG. 4b is a diagram illustrating the electronic device generating a decrypted image on the basis of encrypted data according to an embodiment of the present disclosure.

FIG. 5 is a diagram illustrating a configuration of an electronic device according to an embodiment of the present disclosure.

FIG. 6 is a diagram illustrating a configuration of an image processing unit according to an embodiment of the present disclosure.

FIG. 7 is a diagram illustrating a configuration of a system according to an embodiment of the present disclosure.

### DESCRIPTION OF EXEMPLARY EMBODIMENTS

A description method of the present specification and drawings will be described before the present disclosure will be described in detail.

First, the terms used in the present specification and claims are selected as general terms in consideration of functions in various embodiments of the present disclosure. However, these terms may vary depending on the intention of technicians working in the relevant technical field, legal or technical interpretation, and the emergence of new technologies. Further, some terms may be terms arbitrarily selected by the applicant. These terms may be interpreted as defined in the present specification, and may be interpreted on the basis of overall content of the present specification and common technical knowledge in the relevant technical field when there is no specific term definition.

Further, the same reference numbers or signs described in drawings attached to the present specification denote parts or components that perform substantially the same functions. For convenience of description and understanding, the same reference numerals or signs are used in different embodiments. That is, even when all components having the same reference numbers are illustrated in a plurality of drawings, the plurality of drawings do not represent one embodiment.

Further, in the present specification and claims, terms including ordinal numbers such as “first” and “second” may be used to distinguish between components. These ordinal numbers are used to distinguish the same or similar components from each other, and meaning of the terms should not be construed as being restrictive due to the use of these ordinal numbers. As an example, an order of use or an order of disposition of components combined with the ordinal numbers should not be limited due to the numbers. When necessary, the respective ordinal numbers may be used interchangeably.

In this specification, singular expressions include a plurality of expressions, unless the context clearly dictates otherwise. In the present application, it should be understood that terms such as “comprise” or “configured of” are intended to designate the presence of features, numbers, steps, operations, components, parts, or combinations thereof described in the specification, and do not exclude in advance the presence or addition of one or more other features, numbers, steps, operations, components, parts, or combinations thereof.

In embodiments of the present disclosure, terms such as “module”, “unit”, and “part” are terms for referring to components that perform at least one function or operation, and these components may be implemented by either hardware or software or may be implemented by a combination of the hardware and the software. In addition, a plurality of “modules”, “units”, or “parts”, for example, may be integrated into at least one module or chip and implemented as at least one processor, except in a case in which each of the modules, units, or parts needs to be implemented by individual specific hardware.

Further, in an embodiment of the present disclosure, when a part is connected to another part, this includes not only direct connection but also indirect connection through another medium. In addition, the fact that a certain part includes a certain component does not mean that other components are excluded, but means that other components may be further included unless specifically stated to the contrary.

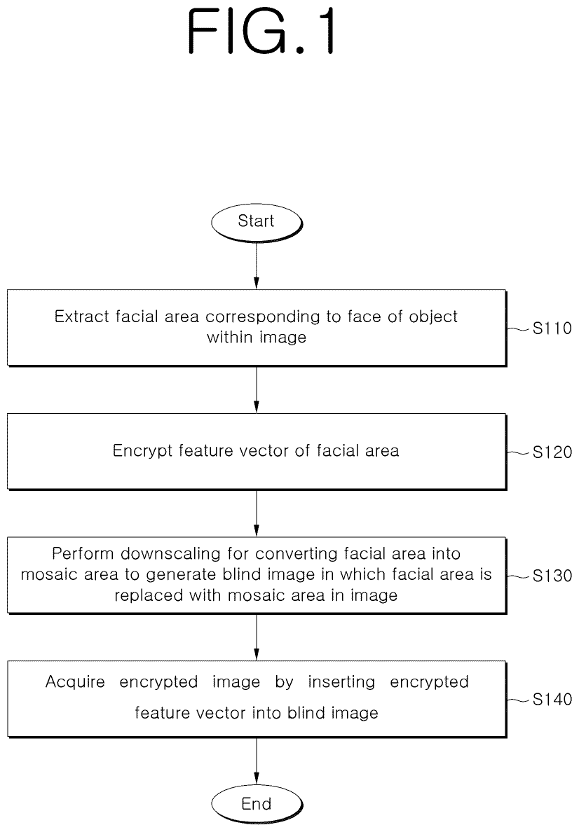

FIG. 1 is a flowchart illustrating an operation in which an electronic device acquires an encrypted image according to an embodiment of the present disclosure.

The electronic device 100 may be implemented by various devices for acquiring the encrypted image on the basis of an input image. For example, the electronic device 100 may be implemented as at least one computer, server, inspection device, robot, drone, camera device, or the like, or may be implemented as a terminal device such as a tablet PC, smartphone, VR device, and AR device.

Referring to FIG. 1, the electronic device 100 can extract a facial area corresponding to the face of the object within the input image (S110).

Specifically, the electronic device 100 can identify at least one object included in the image, and can distinguish and acquire a facial area which is an image corresponding to a face part of the identified object.

To this end, the electronic device 100 may utilize at least one object recognition model (for example, a CNN model) for recognizing the object in the image. In this case, the electronic device 100 can identify an object included in a continuous image every frame, and can track and extract a facial area of the object even when the image changes.

Further, the electronic device 100 may downscale the extracted facial area to low resolution.

Specifically, the electronic device 100 may downscale the facial area to generate a low-resolution image of the facial area. In this case, the electronic device 100 can generate the low-resolution image through various downscaling methods, such as average value sampling, bicubic interpolation, bilinear interpolation, Gaussian pyramid, and neural network-based downscaling.

In this case, the electronic device 100 can generate a feature vector when the generated low-resolution image is input to an encoder.

In this case, since the electronic device 100 performs downscaling while outputting the feature vector, which allows an image with a smaller capacity to be encoded, there is an advantage that it is possible to reduce a load on the electronic device 100.

Specifically, the electronic device 100 may output an input image input as a feature vector in which information on the image is expressed in a compressed manner through the encoder. Accordingly, the electronic device 100 can input the low-resolution image to the encoder and output a feature vector in which information on a facial area has been compressed.

In this case, the encoder may correspond to an encoder portion of an autoencoder structure.

An autoencoder refers to a neural network structure that outputs a feature vector that matches data when data is input, and reconstructs the input data according to the output feature vector. Accordingly, the encoder of the electronic device 100 may include a configuration corresponding to an encoder portion of an autoencoder neural network that outputs a feature vector when an image is input and is trained so that the input image is reconstructed through the output feature vector.

Meanwhile, the electronic device 100 may encrypt the feature vector of the generated facial area (S120).

In this case, the electronic device 100 may set a private code to encrypt the feature vector. For example, the private code can be set by a user input for setting the private code being received.

In this case, since the feature vector is encrypted with the private code, the electronic device 100 can decrypt the encrypted feature vector only when the set private code is input. Further, the decrypted feature vector can be used to restore the facial area. Detailed description will be provided below.

Meanwhile, the electronic device 100 may perform downscaling for converting the extracted facial area into a mosaic area to generate the blind image in which the facial area is replaced with a mosaic area in the input image (S130).

The mosaic area is an image in which the resolution of the facial area has been reduced. The facial area has the reduced resolution and includes only a small number of pixels even when the area has the same size, so that the facial area cannot be identified.

Accordingly, the electronic device 100 may perform downscaling on the facial area so that the mosaic area has a low resolution. In this case, the electronic device 100 may perform downscaling for sufficiently low resolution so that not only the facial area is identified, but also the mosaic area is not restored as the facial area.

Further, the electronic device 100 may combine the generated mosaic area with the input image to generate the blind image in which the facial area is replaced with a mosaic area.

Specifically, the electronic device 100 may generate the blind image through an image combination method such as a layer-based combination method, patch-based combination method, texture mapping, and optical flow.

For example, the electronic device 100 may generate the blind image by replacing a patch constituting the facial area and a patch constituting the mosaic area in the input image through the patch-based combination method.

Further, the electronic device 100 may generate a combined image on the basis of an artificial intelligence model with a generative adversarial network (GANs) or variational autoencoder (VAE) structure, but only the present disclosure is not limited to the artificial intelligence model or image combination method described above.

The electronic device 100 may acquire an encrypted image by inserting the encrypted feature vector into the blind image through the above-described process (S140).

In this case, the encrypted feature vector can be inserted into the blind image through steganography.

The steganography is a technology that hides specific data inside other data to make it difficult to detect the presence of the hidden data. For example, the electronic device 100 can minimize change in appearance of the blind image by modifying, for example, a pixel value of the blind image through steganography or manipulating noise of the blind image to insert data corresponding to the feature vector, thereby generating an encrypted image.

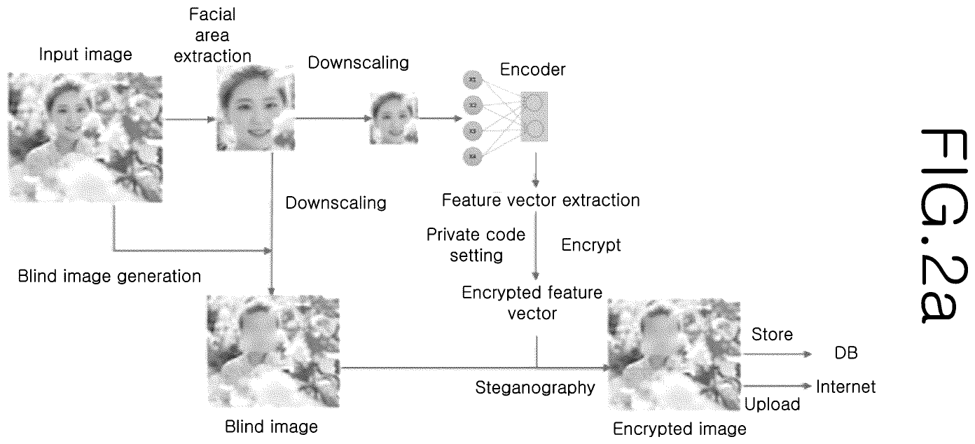

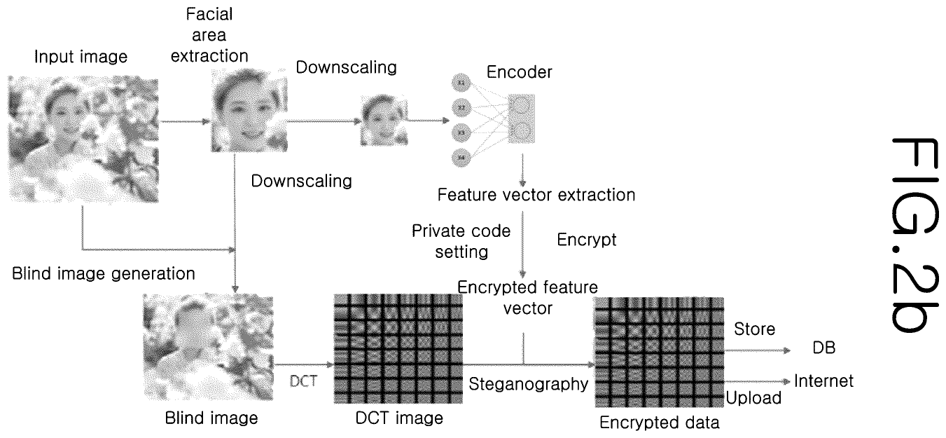

In relation thereto, FIG. 2A is a diagram illustrating an electronic device generating an encrypted image according to an embodiment of the present disclosure.

Referring to FIG. 2a, the electronic device 100 can extract the facial area on the basis of the input image. The electronic device 100 may generate a facial area with low-resolution for extracting a feature vector by downscaling the extracted facial area, and may generate a mosaic area for synthesizing blind images.

In this case, the mosaic area may be downscaled to a lower resolution than the low-resolution image downscaled in order to extract the feature vector.

Further, the electronic device 100 may generate the blind image by combining the mosaic area with the input image.

Further, the electronic device 100 may extract a feature vector by inputting the facial area with low-resolution to the encoder. In this case, the extracted feature vector may be encrypted with a set private code.

The electronic device 100 may generate an encrypted image by inserting the encrypted feature vector into the blind image, and the feature vector may be inserted into the blind image according to the steganography scheme described above.

In this case, the generated encrypted image may be stored in a storage device such as at least one database, or the electronic device 100 may communicate with an external device so that the encrypted image may be provided to the external device.

Meanwhile, the electronic device 100 may compress the image by performing Discrete Cosine Transform (DCT) on the blind image. The DCT is a technology for converting a component of a signal or image into a frequency domain. In this case, a high frequency component of the image converted through DCT corresponds to a fine image component and it is difficult to perceive a difference in image quality even when the component is removed to some extent, and thus, there is an advantage that it is possible to reduce a capacity and noise of the image without greatly changing the image quality by removing the high frequency components.

FIG. 2b is a diagram illustrating an electronic device generating encrypted data on which DCT has been performed according to an embodiment of the present disclosure.

Referring to FIG. 2B, the electronic device 100 may perform DCT on the generated blind image. As a result, the blind image can be converted to a DCT image.

Further, the electronic device 100 may acquire encrypted data by inserting the encrypted feature vector into the DCT image, similar to the method of generating an encrypted image described above.

Meanwhile, the electronic device 100 may extract the feature vector of the encrypted image, restore the image on the basis of the feature vector, and provide the image.

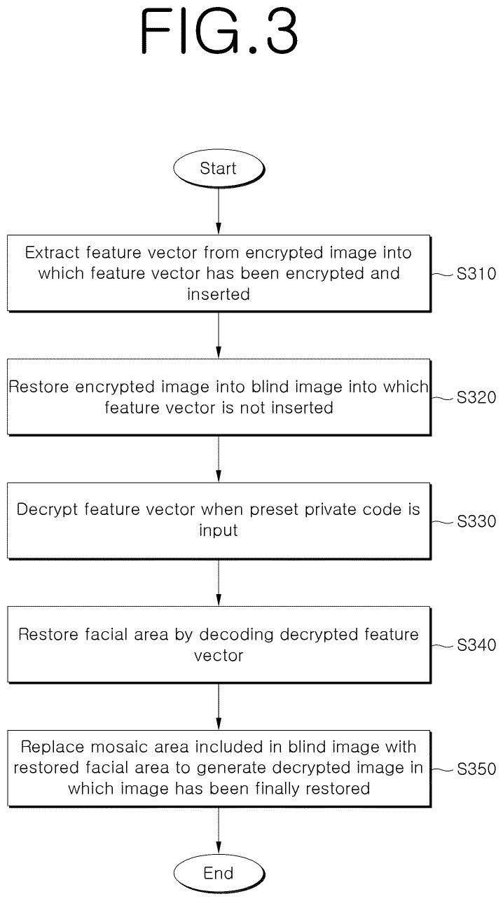

In relation thereto, FIG. 3 is a flowchart illustrating that the electronic device provides a decrypted image restored through an encrypted image according to an embodiment of the present disclosure.

Referring to FIG. 3, the electronic device 100 can extract the feature vector from the encrypted image into which the feature vector has been encrypted and inserted (S310).

In this case, the feature vector in the encrypted image may be inserted on the basis of steganography. Accordingly, the electronic device 100 may use an extraction method corresponding to the method (for example, the steganography) of generating an encrypted image to extract the feature vector from the encrypted image.

Specifically, the encrypted image corresponds to an image in which at least one pixel or frequency has been modulated by applying the encrypted feature vector to the blind image in a steganography format. Accordingly, the electronic device 100 can identify the modulated data (for example, pixel or frequency) and extract the data as a feature vector, to acquire an encrypted feature vector and the blind image.

In this case, a property of the modulated data varies depending on a steganography scheme utilized in the process of S140 or the like, and the electronic device 100 can extract the modulated data from the encrypted image by defining the property of the modulated data, on the basis of the steganography scheme previously performed to generate the encrypted image (S140).

For example, in the case of an encrypted image to which steganography for inserting a feature vector by modifying a pixel value of a blind image is applied, the electronic device 100 can identify a feature of the modified pixel value in the encrypted image, and limit and extract the modified pixel value. Further, the electronic device 100 may reconstruct the feature vector included in the extracted pixel value.

Further, the electronic device 100 may restore the blind image into which the feature vector is not inserted (S320).

Specifically, when the electronic device 100 extracts the feature vector through data modulated in the encrypted image, the electronic device 100 can acquire the blind image by removing data corresponding to the extracted portion.

Further, the electronic device 100 may extract the mosaic area from the acquired blind image. In this case, the extracted mosaic area can be used in a process of restoring a facial area, which will be described below.

Meanwhile, since the extracted feature vector is encrypted, a process of decoding the encrypted feature vector is necessary. In this case, the above-described private code can be used for decryption of the encrypted feature vector.

That is, the electronic device 100 can decrypt the encrypted feature vector when a preset private code is input (S330). To this end, the electronic device 100 may include a component for receiving a user input for inputting the private code.

For example, the electronic device 100 may receive the private code from at least one user terminal through a communication unit, and the electronic device 100 may also include a component such as a user input unit to receive a user input.

The electronic device 100 can restore the facial area by decoding the decrypted feature vector (S340). In this case, the electronic device 100 may decode the feature vector through a decoder.

The decoder may correspond to a decoder portion of the autoencoder described above. That is, the decoder of the electronic device 100 may include a configuration corresponding to a decoder portion of the autoencoder neural network trained to output a feature vector when receiving an image, and reconstruct the input image through the output feature vector.

Further, the electronic device 100 can restore the facial area on the basis of the extracted mosaic area as well as the feature vector.

Specifically, the electronic device 100 may restore a facial area of an input image with low resolution by applying data of the feature vector to the mosaic area. As an example, the electronic device 100 may perform a first restoration process for increasing the resolution of the mosaic area, and in this case, interpolation, scaling, deep learning technology, signal processing according to frequency conversion, or the like may be utilized. Further, the electronic device 100 can restore the facial area by applying the feature vector (decoded according to the decoder) to the first restored mosaic area.

The electronic device 100 may perform upscaling on the restored facial area to generate a high-resolution facial area. In this case, interpolation, scaling, deep learning technology, signal processing according to frequency conversion, and the like can be utilized.

As an example, the electronic device 100 may perform upscaling on the basis of super-resolution. The super-resolution is an image processing technology for restoring a low-resolution image into a high-resolution image.

Specifically, the electronic device 100 may include at least one artificial intelligence model trained to receive a low-resolution image as an input and output a high-resolution image. For example, the electronic device 100 may upscale the restored facial area into a high-resolution facial area through various neural network models such as a convolutional neural network (CNN) and a generative adversarial network (GAN).

Further, the electronic device 100 may perform the above-described image upscaling on the restored blind image.

For example, the electronic device 100 may further perform downscaling on the blind image in the encoder portion. In this case, the encrypted image created on the basis of the blind image can also be transmitted at a low capacity.

Further, the blind image restored in the decoder portion of the electronic device 100 can be up-scaled to a high-quality image, which allows a low-quality image to be transmitted in a communication process, leading to an advantage that capacity can be reduced.

Meanwhile, the electronic device 100 may replace the mosaic area included in the blind image with the restored facial area (on which upscaling has been performed) to generate a decrypted image in which the image has been finally restored (S350). In this case, a decrypted image can be generated through, for example, the image combination scheme or artificial intelligence model described above.

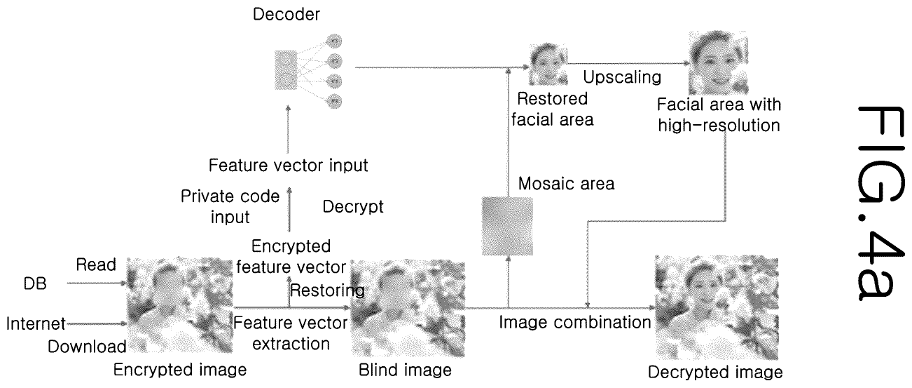

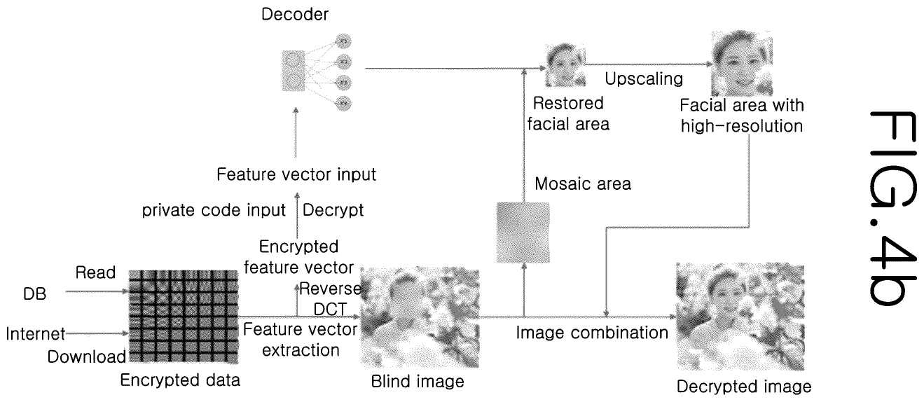

In relation thereto, FIG. 4a is a diagram illustrating an electronic device generating a decrypted image on the basis of an encrypted image according to an embodiment of the present disclosure.

Referring to FIG. 4a, the encrypted image may be provided to the electronic device 100 from a storage device such as a database or an external device.

The electronic device 100 can extract modulated data corresponding to the encrypted feature vector from the encrypted image, and can restore the blind image from the encrypted image by extracting the feature vector.

In this case, the electronic device 100 may extract the mosaic area through the blind image.

Meanwhile, when a preset private code is input, the electronic device 100 can decrypt the encrypted feature vector. In this case, the decrypted feature vector can be decoded through a decoder, and the facial area can be restored on the basis of the mosaic area extracted from the blind image.

Further, the electronic device 100 may generate a high-resolution facial area by performing upscaling on the restored facial area.

In this case, the electronic device 100 may replace the mosaic area of the blind image with a high-resolution facial area on the basis of the generated high-resolution facial area, to generate a decrypted image in which the image has been finally restored.

Meanwhile, the encrypted data generated on the basis of the above-described DCT image, rather than an encrypted image, may be provided to the electronic device 100.

FIG. 4b is a diagram illustrating the electronic device generating a decrypted image on the basis of encrypted data according to an embodiment of the present disclosure.

Referring to FIG. 4b, encrypted data in which an encrypted feature vector is inserted into a DCT image generated by performing DCT on the blind image instead of an encrypted image may be provided to the electronic device 100.

In this case, the electronic device 100 can extract the encrypted feature vector from the encrypted data through a method of S310 and generate a DCT image by removing the feature vector from the encrypted data. The blind image can be restored by performing inverse DCT on the generated DCT image.

The electronic device 100 can extract the mosaic area through the restored blind image and can restore the facial area on the basis of the feature vector and the mosaic area input to the decoder. The restored facial area may be upscaled to a high-resolution facial area, and the electronic device 100 may generate a decrypted image by combining the high-resolution facial area with the blind image.

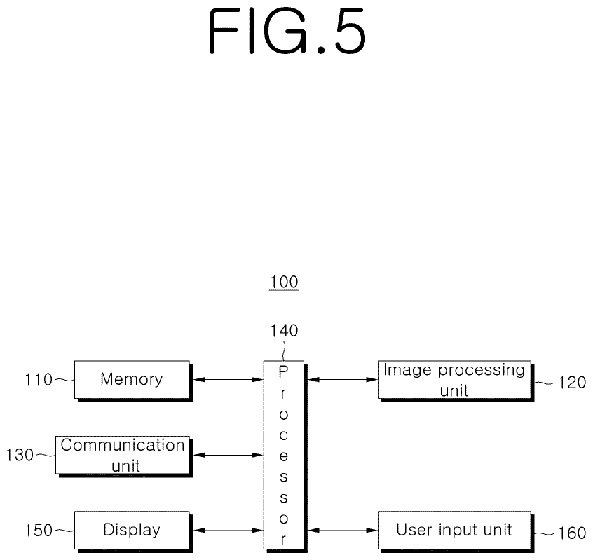

FIG. 5 is a diagram illustrating a configuration of the electronic device according to an embodiment of the present disclosure.

Referring to FIG. 5, the electronic device 100 may include a memory 110, an image processing unit 120, a communication unit 130, and a processor 140.

The memory 110 is configured to store an operating system (OS) for controlling overall operations of the components of the electronic device 100, and at least one instruction or data of the electronic device 100.

The memory 110 may include non-volatile memory such as a ROM or flash memory, and may include a volatile memory such as DRAM. Further, the memory 110 may include a hard disk, solid state drive (SSD), or the like.

In an embodiment, the encrypted image or the encrypted data may be stored in the memory 110, and at least one artificial intelligence model for performing image combination, downscaling, or upscaling may be included.

The image processing unit 120 is a component that allows the electronic device 100 to generate the mosaic area, the blind image, and the decrypted image.

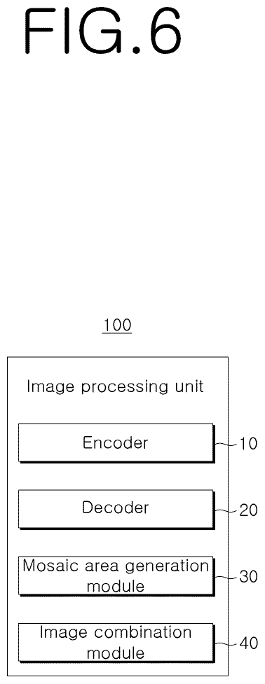

In relation thereto, FIG. 6 is a diagram illustrating a configuration of the image processing unit according to the embodiment of the present disclosure.

Referring to FIG. 6, the image processing unit 120 may include an encoder 10, a decoder 20, a mosaic area generation module 30, and an image combination module 40.

The encoder 10 is configured to extract a feature vector, and the decoder 20 is configured to restore an image through the feature vector. The electronic device 100 can convert a facial area extracted through the encoder 10 into a feature vector, and restore the facial area on the basis of the feature vector through the decoder 20.

The mosaic area generation module 30 is configured to generate a mosaic area by reducing the extracted facial area to low resolution.

The image combination module 40 is configured to generate the blind image or decrypted image by combining generated images. Specifically, the image combination module 40 may generate the blind image by combining the mosaic area generated by the mosaic area generation module 30 with the input image, and combine the decrypted image in which the input image has been reconstructed on the basis of the restored facial area and the blind image.

The communication unit 130 is configured to allow the electronic device 100 to communicate with an external device. The communication unit 130 may include, for example, circuits, modules, and chips for performing communication through various wired and wireless communication schemes. The communication unit 130 may be connected to external devices through various networks.

In an embodiment, the communication unit 130 may receive a private code for encrypting a feature vector through communication with a user terminal.

The network may be a personal area network (PAN), a local area network (LAN), or a wide area network (WAN) depending on an area or size, and may be an intranet, an extranet, or the Internet depending on the openness of the network.

The communication unit 130 can be connected to a manager device 300 and external devices through various wireless communication methods, such as long-term evolution (LTE), LTE Advance (LTE-A), 5th Generation (5G) mobile communication, code division multiple access (CDMA), wideband CDMA (WCDMA), universal mobile telecommunications system (UMTS), wireless broadband (WiBro), global system for mobile communications (GSM), time division multiple access (DMA), WiFi (Wi-Fi), WiFi Direct, Bluetooth, Bluetooth Low Energy (BLE), near field communication (NFC), Zigbee and LoRa.

Further, the communication unit 130 may be connected to external devices through a wired communication scheme such as Ethernet, optical network, USB (Universal Serial Bus), or Thunderbolt.

In addition, the communication unit 130 may be a configured utilizing various communication schemes/technologies that will be newly devised in the future.

The processor 140 is configured to generally control the electronic device 100. Specifically, the processor 140 may be connected to the memory 110 and perform operations according to various embodiments of the present disclosure by executing at least one instruction stored in the memory 110.

The processor 140 may include a general-purpose processor such as a CPU, AP, or a DSP (Digital Signal Processor), a graphics-specific processor such as a GPU, a VPU (Vision Processing Unit), or an artificial intelligence-specific processor such as an NPU. The artificial intelligence-specific processor may be designed with a hardware structure specialized for training or use of a specific artificial intelligence model.

Further, the electronic device 100 may include a display 150 and a user input unit 160.

The display 150 is configured to allow the electronic device 100 to output the blind image or the decrypted image. When a preset private code is input, the electronic device 100 can decrypt the feature vector and output a decrypted image to the display 150, and when a private code is not input, the electronic device 100 can output the blind image instead.

The user input unit 160 is configured to receive input of various commands or information from the user. The user input unit 160 may be implemented by at least one button, touch pad, touch screen, microphone, camera, sensor, or the like.

For example, the electronic device 100 may set a private code for encrypting a feature vector according to a user input received through the user input unit 160, and the set private code may be input to decrypt the feature vector.

Meanwhile, a system including an encoder device and a decoder device may be configured.

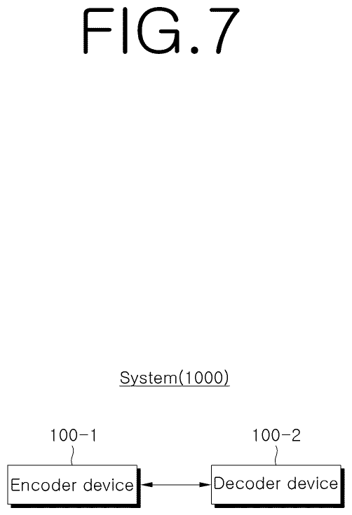

FIG. 7 is a diagram illustrating a configuration of a system according to an embodiment of the present disclosure.

Referring to FIG. 7, a system 1000 may include an encoder device 100-1 and a decoder device 100-2.

The encoder device 100-1 is configured to generate an encrypted image. Specifically, the encoder device 100-1 may correspond to an electronic device for performing FIG. 1 and may include a configuration according to FIG. 5.

The decoder device 100-2 is configured to generate a decrypted image on the basis of the encrypted image provided through the encoder device 100-1. The decoder device may also correspond to an electronic device for performing FIG. 3 and may include the configuration according to FIG. 5.

The encoder device 100-1 and the decoder device 100-2 are separated from each other, but since the image processing unit 120 includes the encoder 10 and the decoder 20, an image may be input to the decoder device 100-2 and encoding may be performed, or the encoder device may perform decoding.

Meanwhile, the various embodiments described above may be implemented by combining two or more embodiments as long as the embodiments do not conflict or contradict each other.

Meanwhile, the various embodiments described above may be implemented in a recording medium that can be read by a computer or a similar device using software, hardware, or a combination thereof.

According to hardware implementation, the embodiments described in the present disclosure may be implemented by using at least one of application specific integrated circuits (ASICs), digital signal processors (DSPs), digital signal processing devices (DSPDs), programmable logic devices (PLDs), and field programmable gate arrays (FPGAs), processors, controllers, micro-controllers, microprocessors, and other electrical units for performing functions.

In some cases, embodiments described herein may be implemented as a processor itself. According to software implementation, embodiments such as procedures and functions described herein may be implemented as separate software modules. Each of the software modules described above may perform one or more functions and operations described herein.

Meanwhile, computer instructions or computer programs for performing processing operations in the electronic device according to various embodiments of the present disclosure described above may be stored in a non-transitory computer-readable medium. The computer instructions or computer programs stored in such a non-transitory computer-readable medium, when executed by a processor of a specific device, cause the specific device to perform processing operations of the electronic device according to the various embodiments described above.

The non-transitory computer-readable medium refers to a medium that stores data semi-permanently and can be read by a device, rather than a medium that stores data for a short period of time, such as registers, caches, and memories. Specific examples of the non-transitory computer-readable medium may include a CD, DVD, hard disk, Blu-ray disc, USB, memory card, and ROM.

Preferred embodiments of the present disclosure have been shown and described above, but the present disclosure is not limited to the specific embodiments described above, and it is obvious that various modifications can be made by those skilled in the art pertaining to the present disclosure without departing from the gist of the present disclosure claimed in the claims, and these modifications should not be understood individually from the technical ideas or perspectives of the present disclosure.

What is claimed is:

1. A method of operating an electronic device, comprising:
extracting a facial area corresponding to a face of an object within an image;
encrypting a feature vector of the facial area;
performing downscaling for converting the facial area into a mosaic area to generate a blind image in which the facial area is replaced with the mosaic area in the image; and
acquiring an encrypted image by inserting the encrypted feature vector into the blind image.

2. The method of operating an electronic device of claim 1, wherein the encrypting of the feature vector of the facial area includes
encoding an image of the facial area to extract the feature vector for the facial area;
receiving a user input for setting a private code for encrypting the feature vector; and
encrypting the feature vector according to the set private code.

3. The method of operating an electronic device of claim 2, wherein the encoding of the image of the facial area to extract the feature vector for the facial area includes
generating a low-resolution image by downscaling the image of the facial area; and
extracting the feature vector by encoding the low-resolution image.

4. The method of operating an electronic device of claim 1, wherein the acquiring of the encrypted image by inserting the encrypted feature vector into the blind image includes
acquiring the encrypted image by inserting the encrypted feature vector into the blind image on the basis of steganography.

5. The method of operating an electronic device of claim 1, comprising:
extracting the encrypted feature vector from the encrypted image and restoring the blind image;
extracting the mosaic area constituting the restored blind image;
decrypting the encrypted feature vector when the set private code is input;
decoding the decrypted feature vector to restore the facial area; and
replacing the mosaic area included in the blind image with the restored facial area to generate the decrypted image in which the image has been finally restored.

6. The method of operating an electronic device of claim 5, wherein
the generating of the encrypted image includes
generating a DCT image by performing Discrete Cosine Transform (DCT) on the blind image, and
inserting the encrypted feature vector into the DCT image to acquire encrypted data matching the encrypted image, and
the extracting of the encrypted feature vector from the encrypted image and restoring of the blind image includes
extracting the encrypted feature vector from the encrypted data matching the encrypted image, and
restoring the blind image by performing inverse DCT on the encrypted data from which the encrypted feature vector is extracted.

7. A method of operating an electronic device, comprising:
downscaling a facial area of an object, replacing the facial area with a mosaic area, and extracting a feature vector for a facial area not subjected to the downscaling from an encrypted image into which the feature vector has been encrypted and inserted;
restoring the encrypted image into a blind image into which the feature vector is not inserted;
decoding the feature vector when a preset private code is input;
decoding the decrypted feature vector to restore the facial area; and
replacing the mosaic area included in the blind image with the restored facial area to generate the decrypted image in which the image has been finally restored.

8. The method of operating an electronic device of claim 7, wherein the feature vector is inserted into the encrypted image on the basis of steganography.

9. The method of operating an electronic device of claim 7, wherein the decoding of the decrypted feature vector to restore the facial area includes
generating a high-resolution facial area by upscaling an image of the restored facial area.

10. A system for providing an image, comprising:
an encoder device configured to downscale a facial area of an object for an input image to generate a blind image in which the facial area is replaced with a mosaic area, and extract a feature vector for the facial area to generate an encrypted image in which the feature vector has been encrypted and inserted into the blind image; and
a decoder device configured of replace the mosaic area with a restored facial area on the basis of the feature vector of the encrypted image, to generate a decrypted image in which the image has been finally restored, and the encrypted image.
